(19) United States
(12) Patent Application Publication
(10) Pub. No.: US 2016/0014851 A1
(43) Pub. Date: Jan. 14, 2016

(54) INDUCTION HEATER COIL ACCESSORY

(71) Applicant: Thomas M Gough, Gilberts, IL (US)

(72) Inventor: Thomas M Gough, Gilberts, IL (US)

(73) Assignee: Sarge Holding Co., LLC, Elgin, IL (US)

(21) Appl. No.: 14/330,429

(22) Filed: Jul. 14, 2014

(51) Int. Cl. H05B 6/36; B21F 3/10

(52) U.S. Cl. CPC H05B 6/36; B21F 3/10

(57) ABSTRACT

An accessory work coil having flattened conductive material, such as flattened wire, for attachment to portable, handheld induction heaters.

### BACKGROUND OF THE INVENTION

The present invention relates to, portable, handheld induction heaters. One use for such induction heaters is in the automotive aftermarket for vehicle repair and maintenance, for selectively heating automotive metallic and adjacent components, and removing components bonded or attached to metallic surfaces (e.g., fasteners), or for removing structure attached by means of adhesive (e.g., glass). Other uses for such induction heaters include heating rods for bending them in a fabrication process, and for annealing ammunition cartridges, etc.

Portable, handheld induction heaters useful in the automotive aftermarket are known. See for example, U.S. Pat. Nos. 6,563,096 and 6,670,590, titled “Eddy Current/Hysteretic Heater Apparatus And Method Of Use” and “Eddy Current/ Hysteretic Heater Apparatus,” respectively, each of which is incorporated by reference in its entirety into this application. Pending U.S. Ser. No. 14,065,844, filed Oct. 29, 2013, titled “Portable Induction Heater,” and disclosing, e.g., handheld induction heaters which can run on power supplied at 12-24 volts, as well as 110-240 volts, is hereby incorporated by reference in its entirety as well.

In addition to induction heaters, other heating devices have been used in the automotive aftermarket and other fields, such as oxy/acetyelene torches and penetrating oils. Torch use is limited to areas that will not cause collateral damage to nearby components/surfaces, or where such components can be removed or such surfaces can be protected so as not to damage them in the heating process, creating unnecessary labor. Penetrating oils do not necessarily work in many applications and can be messy, or even unintentionally dissolve or otherwise damage certain plastic components. For the most part, induction heaters have proven efficacious for certain applications, such as removing rusted, bonded and/or painted fasteners and adhesively-attached structures such as glass.

Induction heaters may be air-cooled or water-cooled. The present invention concerns air-cooled induction heaters. Three main components of a modern induction heater include the power unit (power inverter), optional output/isolation transformerand the coil (inductor). Induction heating is a non-contact method of heating a conductive body by utilizing a strong magnetic field. Induction heaters may incorporate a coil directly fed from the electricity supply. The power unit/inverter is used to take the supply/mains frequency and increase it to a higher frequency, typically anywhere between 1-400 kHz. Typical power output of a unit system may be about 1-500 kW. The work head/transformer may include a combination of capacitors and transformers used to mate the power unit to the work coil. The work coil/inductor is used to transfer the energy from the power unit and work head to the work piece. Inductors of the type of the present invention consist of a simple wound solenoid with a number of turns of copper tube wound around a mandrel. As the inductor is the area where the heating takes place, coil design is an important element of the induction heater.

To work properly, the coil must he placed in close proximity to the work piece (e.g., a nut to be loosened). This can be difficult in tight or difficult to access areas and/or where there are closely adjacent surfaces to the work piece, which the operator does not wish to heat or damage.

A conventional coil configuration used for handheld induction heaters utilizes round conductor wire (e.g., copper), which may be bent such as in the shape shown in prior art FIG. 1. Due to the amount of current necessary to achieve the necessary heat, reducing the wire mass may not be an option, particularly if tight space tolerances are involved. Additionally, closed loop work coils such as shown in FIG. 1 may not be feasible in a given application, given the shape and configuration of the work piece to be heated, such as an in-line connector (FIG. 3) or other work piece to be heated, in which the coils are unable to encompass the work piece.

### DEFINITION OF CLAIM TERMS

The following terms are used in the claims of the patent as filed and are intended to have their broadest meaning consistent with the requirements of law. Where alternative meanings are possible, the broadest meaning is intended. All words used in the claims are intended to be used in the normal, customary usage of grammar and the English language.

“Accessory” as in “accessory work coil” means that the work coil can be replaced with another work coil, either because of durability concerns or because a differently shaped or sized work coil is desired to be used for a certain application.

“Automotive applications” means applications for selectively heating automotive metallic and adjacent components, and removing components bonded or attached to metallic surfaces (e.g., fasteners), or for removing structure attached by means of adhesive (e.g., glass, parts, components).

“Coil” or “work coil” means the portion of the induction heater used to heat a work piece, which may include a connection between the coil and the induction heater, which may be comprised of an extension cable, for example, or a pair of legs attachable to and removable from the induction heater body, and either an open or closed loop permanently attached to and/or integrally formed with the legs.

“Closed loop” refers to a distal, working portion of the work coil which includes one or more adjacent circular loops or bands.

“Open loop” refers to a distal, working portion of the work coil which has a curved cross-section, such as a semi-circular, semi-cylindrical or semi-elliptical cross-section, and opposing, spaced-apart ends.

### SUMMARY OF THE INVENTION

The objects mentioned above, as well as other objects, are solved by the present invention, which overcomes disadvantages of prior portable induction heaters, while providing new advantages not previously obtainable with such heaters.

In a preferred embodiment, a thin-wall accessory work coil for attachment and use with a portable induction heater is provided, and includes: two or more conductor legs removably attachable to the induction heater; and a closed loop conductor having one or more curvilinear bands, such as flattened copper wire. The one or more bands may have a substantially flat cross-section, and a width of the one or more bands may be substantially greater than a thickness of the one or more bands.

The induction heater of the present invention may be used in automotive applications, such as to remove fasteners or to remove adhesively bonded items such as glass. The induction heater of the present invention may also be used in non-automotive applications, such as to heat rods for bending them in a fabrication process, for annealing ammunition cartridges, etc.

In another preferred embodiment of the present invention, a thin-wall accessory work coil for attachment and use with a portable induction heater is provided, and includes: two or more conductor legs removably attachable to the induction heater; and an open loop conductor having one or more curvilinear bands. The one or more bands may have a substantially flat cross-section in which a width of the one or more bands is substantially greater than a thickness of the one or more bands. The open loop conductor may have a curved cross-section and two edges which are spaced apart.

In still another preferred embodiment of the present invention, a method for forming a thin-wall accessory work coil for attachment and use with a portable induction heater is provided. In this embodiment, a predetermined length of conductive wire with a circular cross-section having a predetermined current-carrying capacity is located. Next, the wire is flattened, and formed into a closed or open loop configuration having one or more curvilinear bands. The one or more bands may have a substantially flat cross-section, and a width of the one or more bands may be substantially greater than a thickness of the one or more bands. After flattening the wire, it may be desirable to form the wire around an object to configure the wire into a desired shape. It may also be desirable to cut or stamp the wire from a substrate instead of flattening the wire, prior to forming the wire into the closed or open loop configuration.

### BRIEF DESCRIPTION OF THE DRAWINGS

The novel features which are characteristic of the invention are set forth in the appended claims. The invention itself, however, together with further objects and attendant advantages thereof, will be best understood by reference to the following description taken in connection with the accompanying drawings, in which:

FIG. 1 is a side perspective view of a prior art, closed-loop work coil used with portable induction heaters;

FIG. 2 is a side perspective view of a preferred embodiment of a thin-wall, closed-loop work coil of the present invention;

FIG. 3 is a top and side perspective view of a conventional in-line connector to be disassembled, i.e. a desired “work load, located above a thin-wall, open-loop work coil of the present invention;

FIG. 4 is a top and side perspective view of the thin-wall, open-loop work coil shown in FIG. 3, in position to induction-heat the in-line connector shown in FIG. 3;

FIGS. 5A-5D are schematic diagrams comparing the conductive area/skin effect for round and rectangular geometries at 50 Khz and 25 Khz current flows; and

FIGS. 6A and 6B are diagrammatic views showing a process for making a flat planar coil.

The components in the drawings are not necessarily to scale, emphasis instead being placed upon clearly illustrating the principles of the present invention. In the drawings, like reference numerals designate corresponding parts throughout the several views.

### DETAILED DESCRIPTION OF THE PREFERRED EMBODIMENTS

Set forth below is a description of what are currently believed to be the preferred embodiments and/or best examples of the invention claimed. Future and present alternatives and modifications to this preferred embodiment are contemplated. Any alternatives or modifications which make insubstantial changes in function, in purpose, in structure, or in result are intended to be covered by the claims of this patent.

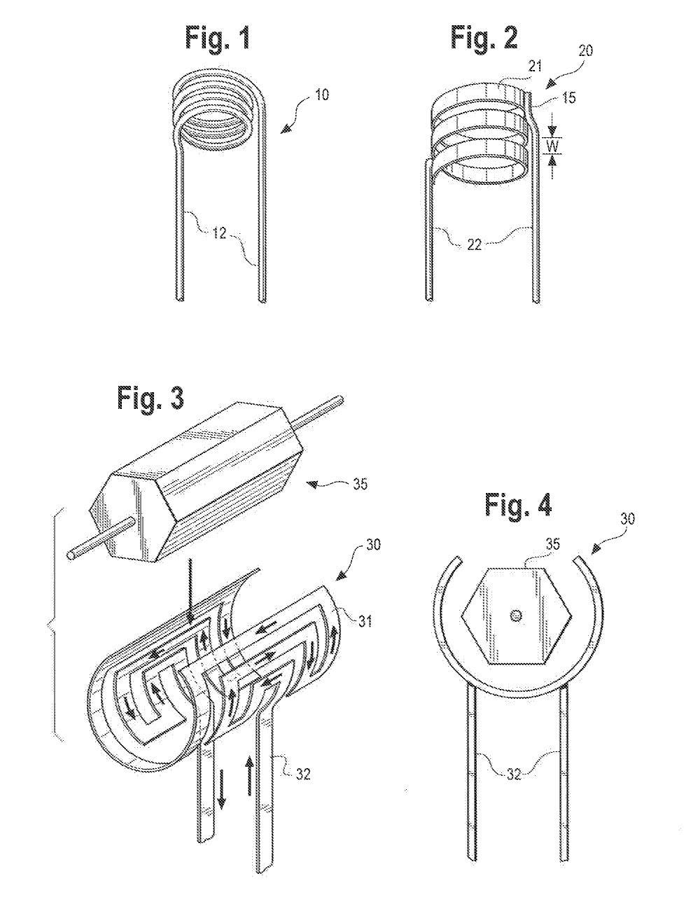

Referring first to prior art FIG. 1, in a particularly preferred embodiment of the present invention, inductor coil 10 is shown, having legs 12 for connection to the working end of an induction heater (not shown). Coil 10 may be made of round copper wire or another suitable round conductive wire.

Referring now to FIG. 2 of the present invention, inductor coil 20 may include coils 21 consisting of conductive wire that has been formed into a non-round shape, such as being flatter and wider than round wire, but which may have a similar mass in comparison to the normal gauge wire that conventionally may be used for aftermarket automotive applications (e.g. 8-10 gauge). As one non-limiting example, the coil shown in FIG. 2 may be of copper, and may have a thickness of 0.040-inches, and a width “W” of 0.20-inches.

Still referring to FIG. 2, since the flux or skin effect is a result of the surface area of the wire, this new flatter configuration can provide a larger space within its coil, which can accommodate a larger-sized work piece within its coil. As each turn of the winding will utilize more space, the circumference need not necessarily change, but the lesser skin effect may not require as many windings to achieve the same desired effect as with the round wire. In contrast, the surface area of a round wire is 2¶r*length, where “r” is the radius of the wire. Thus, as an example, an 8 (American Wire) gauge wire has a diameter of about 0.1285 inches, so its surface area is about 0.40-inches*length. If the width W of the flat wire in FIG. 2 is 0.20-inches, then the surface area of the FIG. 2 is substantially greater, or about 0.48-inches*length (0.20 for each flat side, and 0.04 for each edge). These comparisons are for solid wire, and do not apply to litz (braided) wire, which may be preferred due to the reduced skin effect provided by the number of fine wires offering greater total surface area, but which is structurally flimsy. Copper tubing, which has a greater surface area/mass ratio than solid wire, may also be used; however, copper tubing is typically cooled by water or another liquid, and is much bulkier in use,

“Skin effect” is the tendency of an alternating electric current (AC) to become distributed within a conductor such that the current density is largest near the surface of the conductor, and decreases with greater depths in the conductor. The electric current flows mainly at the “skin” of the conductor, between the outer surface and a level called the skin depth. The skin effect causes the effective resistance of the conductor to increase at higher frequencies where the skin depth is smaller, thus reducing the effective cross-section of the conductor. The skin effect is due to opposing eddy currents induced by the changing magnetic field resulting from the alternating current. At 60 Hz in copper, for example, the skin depth is about 8.5 mm. At high frequencies the skin depth becomes much smaller. Increased AC resistance due to the skin effect can be mitigated by using multiple fine conductor lizt wire, which may also be specially woven.

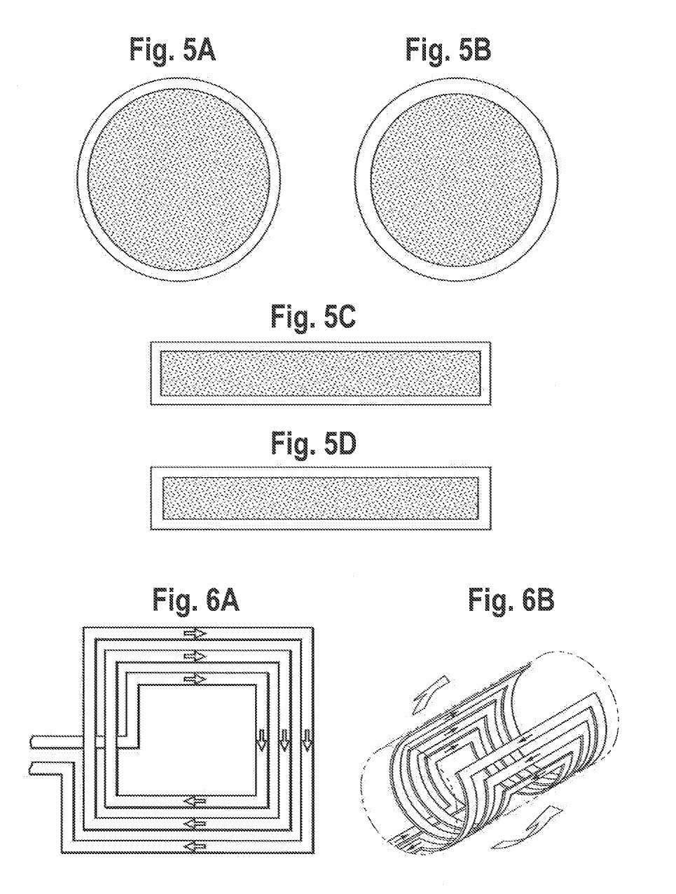

Analysis confirms that the new flatter-configuration coil yields a greater conductive area or reduced skin effect than round wire coil of the same mass, providing better heating results than round wire. For example, referring to FIG. 5, FIGS. 5A and 5C compare the conductive area/skin effect (dark outer band) for 50 Khz current flow through round (FIG. 5A, in which wire radius is 0.125 inches) and rectangular (FIG. 5C, in which length is 0.217 inches and width is 0.04 inches) wire geometries, showing that the conductive area for the round geometry (0.00216) is substantially less than that for the flattened rectangular geometry (0.00283 square inches). (An on-line skin effect calculator was used: http://www.rfcafe.com/references/calculators/skin-depth-calculator.htm). Comparing FIGS. 5B and 5D with the same geometries and different skin effects, similar results apply for 25 Khz current flow through the same corresponding geometries (0.00299 square inches for FIG. 5B versus 0.00392 square inches for FIG. 5D). Overall, this analysis shows that flattened wire yielded a 31% greater conductive area than round wire. Precise results will vary depending on the specific geometry involved, of course, but the general conclusion follows for shapes and sizes generally corresponding to these.

Referring to FIG. 2, it may be desirable to provide the flat-wire coil with a bend 15 on the legs 12 of the coil, as shown. Bending the legs 22 into the desired direction facilitates attachment of the work coil to the power supply (inverter). After attachment to the power supply, the legs can then be further bent/configured to obtain the desired positioning/angle of the work coil to the work load (i.e., the object which is desired to be heated). The legs do not necessarily need to be bent parallel to the cylindrical shape of the work coil; instead, they can be formed adjacent to the radius of the coil as well. Due to the enhanced flexibility of a flatter material, the coil can be adjusted to different shapes/sizes subject to the requirements of the mass of the material and/or the desired diameter of the coil given the work piece.

Referring now to FIGS. 3-4 (current flow shown by direction of arrows), this flat-wire principle can be applied to open access work coils 30, with flattened, open cylindrical-shaped coil 31 and legs 32, which can be used to heat work pieces such as in-line connector 35, as shown. Again, the flat wire coil provides a greater surface area, and thus a greater flux, while providing a larger inner space to envelope the work piece.

In an alternative embodiment, an open loop coil may be fabricated using round wire as well, although this may not be as desirable given the greater skin effect. However, given available materials, this may be advantageous.

To enhance electrical insulation, the coils may be covered with a heat-treated saturated fiberglass sleeving available from many insulation re-sellers and McMaster Carr,

Standard 8-10 gauge wire can be flattened to a desired specification, thus maintaining the necessary cross-section for current.

By inducing a high frequency magnetic current into the new work coil, enhanced access to work pieces can be achieved,

A method for forming a work coil of the present invention may include forming the wire around an object to achieve the desired shape. Alternatively, the substrate may be cut and/or stamped from a sheet stock of conductive material of desired thickness, and it may then be formed into the desired shape by forming it around an object, for example. It may be desirable to braze the legs in order to attached them to the coil, as opposed to integrally forming the legs with the coil.

Referring to FIG. 6A, in one preferred method for forming an open end coil, a flat planar coil is formed, in which current flow is shown by the direction of the arrows. Current in adjacent parallel windings should flow in the same direction so as not to cancel each other out. Referring to FIG. 6B, the flat coil may then be formed around a cylindrical object in order to form the final coil shape.

The above description is not intended to limit the meaning of the words used in the following claims that define the invention. For example, while various preferred and less preferred embodiments have been described above, persons of ordinary skill in the art will understand that a variety of other designs still falling within the scope of the following claims may be envisioned and used. It is contemplated that future modifications in structure, function or result will exist that are not substantial changes and that all such insubstantial changes in what is claimed are intended to be covered by the claims.

1. A thin-wall accessory work coil for attachment and use with a portable induction heater, comprising:
two or more conductor legs removably attachable to the induction heater; and
a closed loop conductor comprising one or more curvilinear bands, the one or more bands having a substantially flat cross-section.

2. The thin-wall accessory work coil of claim 1, wherein a width of the one or more bands is substantially greater than a thickness of the one or more bands.

3. The thin-wall accessory work coil of claim 1, wherein the induction heater is used in automotive applications.

4. The thin-wall accessory work coil of claim 1, wherein the induction heater is used in non-automotive applications.

5. The thin-wall accessory work coil of claim 2, wherein the induction heater is used to remove fasteners or to remove adhesively bonded items.

6. The thin-wall accessory work coil of claim 1, wherein the one or more bands comprise flattened copper wire.

7. A thin-wall accessory work coil for attachment and use with a portable induction heater, comprising:
two or more conductor legs removably attachable to the induction heater; and
an open loop conductor comprising one or more curvilinear bands.

8. The work coil of claim 7, wherein the one or more bands have a substantially flat cross-section in which a width of the one or more bands is substantially greater than a thickness of the one or more bands.

9. The work coil of claim 7, wherein the open loop conductor has a curved cross-section and two edges which are spaced apart.

10. A method for forming a thin-wall accessory work coil for attachment and use with a portable induction heater, comprising the steps of:
providing a predetermined length of conductive wire with a circular cross-section having a predetermined current-carrying capacity;
flattening the wire, and forming the wire into a closed or open loop configuration having one or more curvilinear bands, wherein the one or more bands have a substantially flat cross-section.

11. The method of claim 10, wherein a width of the one or more bands is substantially greater than a thickness of the one or more bands.

12. The method of claim 10, further comprising the step, after flattening the wire, of forming the wire around an object to configure the wire into a desired shape.

13. The method of claim 10, further comprising the step of cutting or stamping the wire from a substrate instead of flattening the wire, and prior to forming the wire into the closed or open loop configuration.
